(19) United States
(12) Patent Application Publication
(10) Pub. No.: US 2025/0210916 A1
(43) Pub. Date: Jun. 26, 2025

(54) CONNECTION STRUCTURE

(71) Applicant: TOYOTA JIDOSHA KABUSHIKI KAISHA, Toyota-shi Aichi-ken (JP)

(72) Inventor: Tadaaki SHIMOHIGASHI, Fukuyama-shi Hiroshima-ken (JP)

(73) Assignee: TOYOTA JIDOSHA KABUSHIKI KAISHA, Toyota-shi Aichi-ken (JP)

(21) Appl. No.: 18/970,156

(22) Filed: Dec. 5, 2024

(30) Foreign Application Priority Data
Dec. 22, 2023 (JP) 2023-217345

(51) Int. Cl. H01R 13/635; B60L 3/04; H01M 50/204; H01M 50/284

(52) U.S. Cl. CPC H01R 13/635; H01M 50/204; H01M 50/284; B60L 3/04; H01M 2220/20

(57) ABSTRACT

A connection structure in which an electronic device and a battery are electrically connected via a connector, the connector including a first connector provided on a side of the electronic device connected to the high voltage circuit, and a second connector provided on a side of the battery module connected to the first connector. Further, the electronic device includes a release member, which relatively moves towards a direction to release the connection of the second connector with respect to the base, and the release member, when a load in the direction to release the connection is input from the housing, moves in the direction for releasing the connection of the second connector and apply a load to the second connector so as to release the connection with the first connector.

### CROSS-REFERENCE TO RELATED APPLICATION(S)

The present application claims priority to and incorporates by reference the entire contents of Japanese Patent Application No. 2023-217345 filed in Japan on Dec. 22, 2023.

### BACKGROUND

The present disclosure relates to a connection structure.

Japanese Laid-open Patent Publication No. 2015-137008 discloses a connection structure which is electrically connected to the battery module and the electronic device in a space formed by the floor panel in the electric vehicle equipped with a battery module.

### SUMMARY

There is a need for providing a connection structure capable of avoiding heat generation of the battery cell even if a short circuit occurs in the electronic device side.

According to an embodiment, provided is a connection structure in which an electronic device having a high voltage circuit and a battery module having a plurality of battery cells are electrically connected via a connector. Further, the connector includes a first connector provided on a side of the electronic device, which is connected to the high voltage circuit, and a second connector provided on a side of the battery module, which is connected to the first connector, the first connector is integrated with a base on which the high voltage circuit is provided, the electronic device includes a release member, which relatively moves towards a direction to release the connection of the second connector with respect to the base to release the connection of the second connector, the release member being provided in a housing accommodating the base, and the release member, when a load in the direction to release the connection is input from the housing, moves in the direction for releasing the connection of the second connector and apply a load to the second connector so as to release the connection with the first connector.

### BRIEF DESCRIPTION OF THE DRAWINGS

FIG. 1 is a diagram schematically illustrating a connection structure in the embodiment;

FIG. 2 is a diagram for explaining a construction of a cell ECU;

FIG. 3 is a perspective view for explaining a condition in which a female connector of a battery module side is connected to a male connector of a battery ECU side;

FIG. 4 is a top view for explaining a condition in which the female connector of the battery module side is connected to the male connector of the battery ECU side;

FIG. 5 is a side view for explaining a condition in which the female connector of the battery module side is connected to the male connector of the battery ECU side;

FIG. 6 is a sectional view illustrating a cross-section taken along the line A-A of FIG. 5;

FIG. 7 is a sectional view illustrating a cross section taken along the line B-B of FIG. 5; and

FIG. 8 is a diagram for explaining an operation when a load due to crushing acts on a release member.

### DETAILED DESCRIPTION

In the configuration described in Japanese Laid-open Patent Publication No. 2015-137008, the floor panel is deformed such as electric vehicle collides, when the device box for housing the electronic device is crushed, the electronic device including the high voltage circuit is crushed short-circuited. When the electronic device is short-circuited, a large current flows from the electronic device to the battery cell through the conductive member, there is a possibility that the battery cell generates heat.

Hereinafter, the connection structure in the embodiment of the present disclosure will be specifically described. Note that the present disclosure is not limited to the embodiments described below.

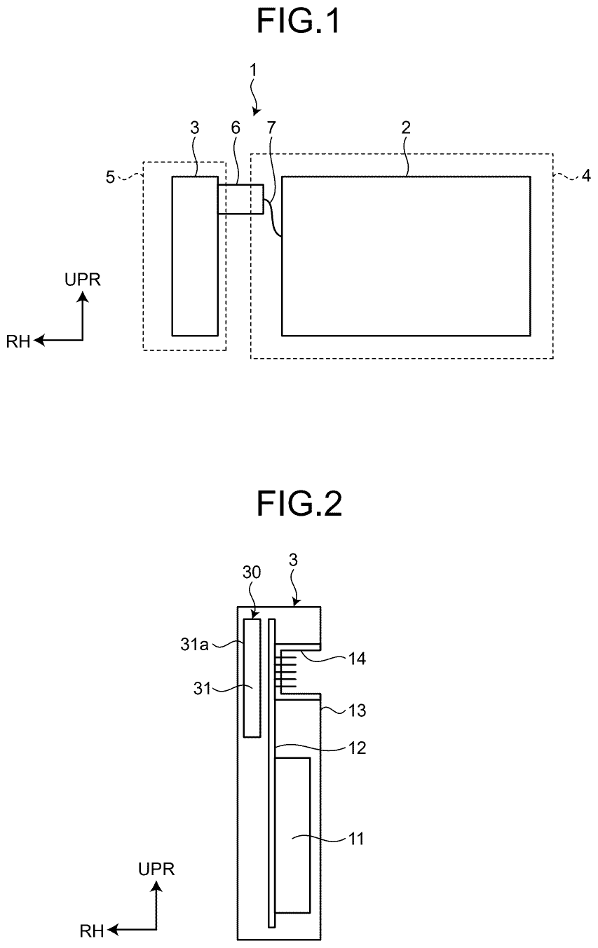

FIG. 1 is a diagram schematically illustrating a connection structure in the embodiment. A connection structure 1 is a structure in which a battery module 2 and a battery electronic control unit (ECU) 3 are electrically connected. The connection structure 1 is applied to an electric vehicle. The electric vehicle is a vehicle equipped with a motor for running, such as a hybrid electric vehicle (HEV), a plug-in hybrid electric vehicle (PHEV) and a battery electric vehicle (BEV). The battery module 2 and the battery ECU 3 are mounted on the electric vehicle while being accommodated in the housing case of the battery pack. In the housing case of the battery pack, together with the battery module 2 is accommodated in the module case 4, the battery ECU 3 is accommodated in the device box 5. A module case 4 and a device box 5 is fixed to the housing case of the battery pack.

The battery module 2 is an assembled battery constituted by a plurality of battery cells. The battery module 2 is housed inside the module case 4. The battery module 2 is electrically connected to the battery ECU 3 via the female connector 6. The female connector 6 and the battery module 2 are electrically connected via a flexible printed cable (FPC) 7.

The battery ECU 3 is an electronic controller that controls the battery module 2. A cell ECU 3 includes a processor and a memory. The battery ECU 3 loads the program stored in the storage unit into the working area of the memory and executes the program to control the components through the execution of the program, thereby realizing a function that meets a predetermined objective. The signals from various sensors mounted on electric vehicles are inputted into the cell ECU 3. The battery ECU 3 performs battery control on the basis of signals inputted from various sensors. The battery ECU 3 outputs various command signals to the battery module 2 in accordance with the battery control. At that time, a command signal is transmitted from the battery ECU 3 to the battery module 2 through the female connector 6.

As illustrated in FIG. 2, the cell ECU 3 includes a high-voltage circuitry 11, a base 12, a housing 13, and a male connector 14.

The high voltage circuit 11 is provided on the base 12. The base 12 is an ECU board. The housing 13 is an ECU housing. The male connector 14 is attached to the base 12. The male connector 14 is integrated with the base 12. The male connector 14 has a pin which is electrically connected to the high voltage circuit 11. In the cell ECU 3 the high-voltage circuitry 11 and the base 12 is housed within the housing 13. The cell ECU 3 is an electronic device having high-voltage circuitry 11. The male connector 14 has a structure capable female connector 6 is connected from the outside of the housing 13. The female connector 6 from the outside of the housing 13 is fitted to the male connector 14, by the pin of the terminal and the male connector 14 of the female connector 6 is electrically connected, the battery ECU 3 and the battery module 2 is electrically connected via the female connector 6. In the connection structure 1, the male connector 14 is a first connector, the female connector 6 is a second connector.

In the battery pack including the battery module 2 and the battery ECU 3 configured in this way, there is a possibility that the battery ECU 3 having the high-voltage circuitry 11 is crushed and short-circuited when the device box 5 crushes due to its structure. At that time, a large current flow through the battery module 2 through the FPC 7, and the battery cell generates heat. In other words, when the battery ECU 3 collapses, the built-in high-voltage circuitry 11 is short-circuited, and a large current flow into the battery cell, resulting in heat generation. In order to avoid this heat generation, the circuit is usually cut off by a fuse, but due to the limitation of the body size and mountability of the battery pack, it is difficult to use a fuse that meets the rating. Therefore, in the connection structure 1, by utilizing the load at the time of crushing, it is configured to cut off the short circuit by physically disconnecting the female connector 6. As illustrated in FIG. 2, the connection structure 1 includes a release member 30 within the housing 13 of the cell ECU 3 for releasing the connection of the female connector 6.

The release member 30 is a member for releasing the connection state between the female connector 6 and the male connector 14. The release member 30 is constituted by an insulator such as resin. For example, the release member 30 is integrally molded of resin. The release member 30 functions as a pushing mechanism that presses the female connector 6 in the release direction to release the connection between the female connector 6 and the male connector 14.

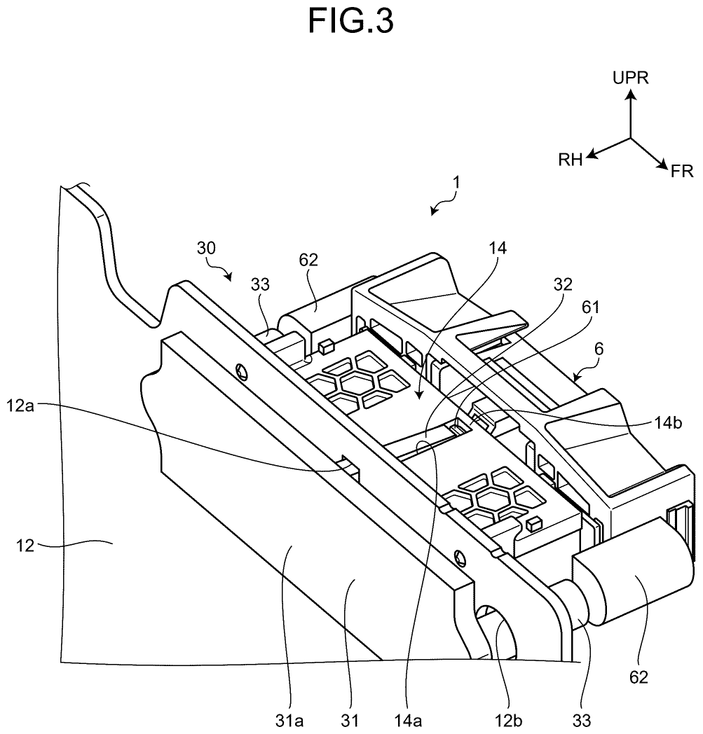

As illustrated in FIG. 3, the release member 30 has a flat plate portion 31, a release pin 32, and a pressing portion 33.

The flat plate portion 31 is a body portion of the release member 30, a plate portion of the planar shape facing the base 12 in the horizontal direction. The flat plate portion 31 is a portion for receiving a load for moving the release member 30 in the release direction. The flat plate portion 31 is disposed on the opposite side of the male connector 14 with respect to the base 12. The flat plate portion 31 is disposed at a position away from the base 12 in the horizontal direction. The flat plate portion 31 has a planar 31a facing away from the male connector 14 in the horizontal. The planar 31a is a surface which the load releasing direction from the housing 13 when the housing 13 is crushed is inputted.

The release pin 32 is a convex portion of the pin-shaped projecting from the flat plate portion 31 to the female connector 6 side. The release pin 32 is a portion for releasing the claw 61 of the female connector 6. The female connector 6 has a claw 61 for locking the body of the male connector 14 so as not to fall out from the male connector 14 in the release direction. The claw 61 is a locking claw for preventing the withdrawal of the female connector 6. The release pin 32 is provided at a position to remove the claw 61.

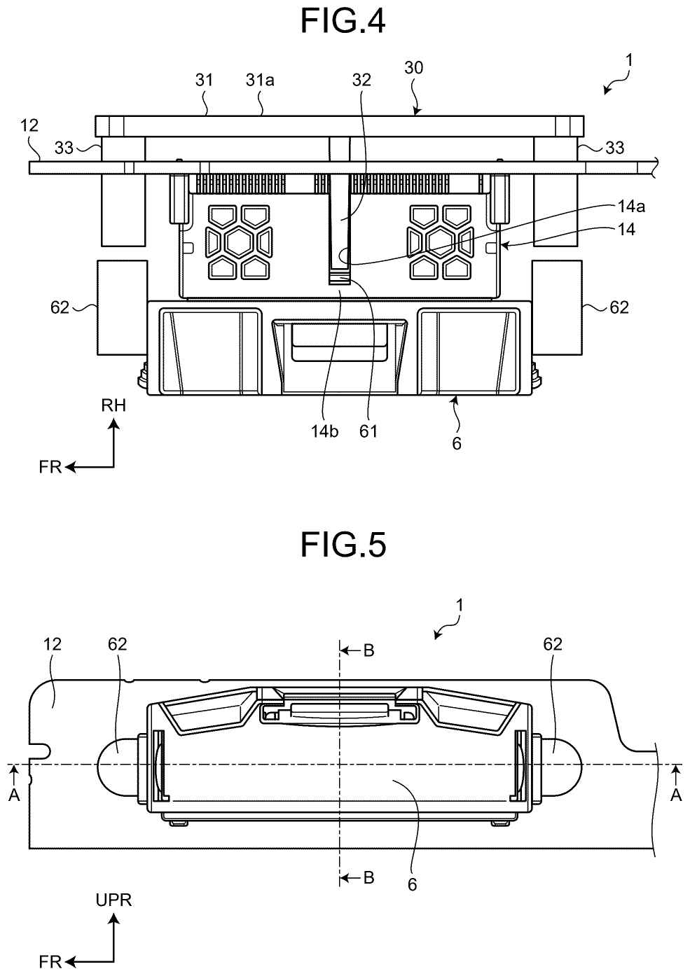

The release pin 32 is disposed inside the guide portion 14a of the male connector 14 through the base 12 from the flat plate portion 31. The base 12 has a through hole 12a release pin 32 is inserted, and a through hole 12b in which the pressing portion 33 is inserted. The male connector 14 has a guide portion 14a where release pin 32 is inserted. The through hole 12a is provided at a position corresponding to the release pin 32. The guide portion 14a is provided at a position corresponding to the through-hole 12a, and communicates with the through-hole 12a. The guide portion 14a is formed by a notch extending linearly along the horizontally. As illustrated in FIGS. 3 and 4, the release pin 32 is inserted into the through hole 12a, and is disposed inside the guide portion 14a. The claw 61 is provided on the main body of the female connector 6 of the guide portion 14a. The male connector 14 has a standing wall 14b claw 61 is engaged. The standing wall 14b is a part of the male connector 14 body, a portion located between the guide portion 14a and the female connector 6 horizontally. A standing wall portion 14b is the engaged portion. When the claw 61 is engaged with the standing wall portion 14b, a condition in which the female connector 6 is fitted to the male connector 14 is maintained.

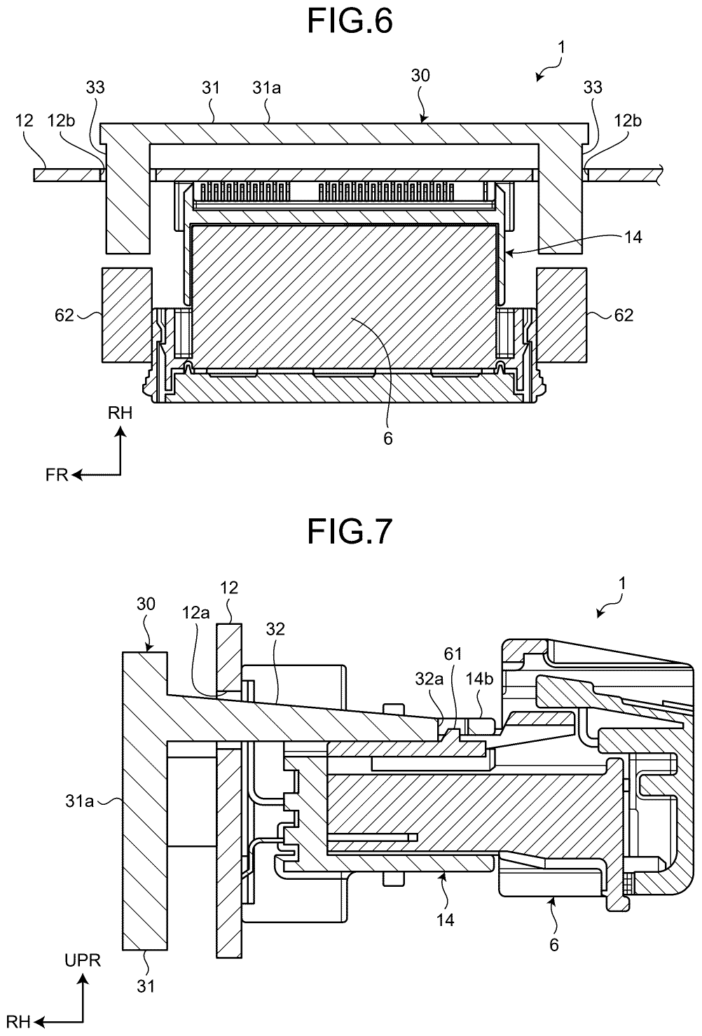

The pressing portion 33 is a convex portion of the rod-shaped projecting from the flat plate portion 31 to the female connector 6 side. The pressing portion 33 is a portion for pushing the female connector 6 in the release direction. The pressing portion 33 protrudes in the same direction as the release pin 32 is provided two on both sides of the male connector 14 so as to sandwich the release pin 32. As illustrated in FIGS. 3 and 4, the pressing portion 33 is provided at a position corresponding to the receiving portion 62 of the female connector 6. The pressing portion 33 and the receiving portion 62 in the horizontal direction are opposed. As illustrated in FIG. 4, in a state where the claw 61 is engaged with the male connector 14, the pressing portion 33 is not in contact with the receiving portion 62. When the release member 30 by crushing of the housing 13 is moved in the release direction, the pressing portion 33 presses the receiving portion 62 in contact with the receiving portion 62 of the female connector 6 in the release direction. As illustrated in FIGS. 4 and 5, the receiving portion 62 is provided on both sides of the body of the female connector 6. As illustrated in FIGS. 4 to 6, the pressing portion 33 extends linearly along the release direction to the vicinity of the receiving portion 62 through the through-hole 12b of the base 12.

As illustrated in FIGS. 4, 6, and 7, in a state in which the release member 30 is not moved in a direction to release the connection of the female connector 6, the horizontal distance between the base 12 and the flat plate portion 31 is longer than the horizontal distance between the release pin 32 and the claw 61, and is longer than the horizontal distance between the pressing portion 33 and the receiving portion 62. Thus, before the flat plate portion 31 is in contact with the base 12 in the release direction, it is possible for the release pin 32 to contact with the claw 61, and for the pressing portion 33 to contact with the receiving portion 62. Further, in this state, the horizontal distance between the pressing portion 33 and the receiving portion 62 is longer than the horizontal distance between the release pin 32 and the claw 61. Thus, before the pressing portion 33 in the release direction abuts against the receiving portion 62, it is possible for the release the pin 32 to abuts against the claw 61. Furthermore, in this condition, the horizontal distance between the release pin 32 and the standing wall 14b is longer than the horizontal distance between the pressing portion 33 and the receiving portion 62. Thus, prior to the release pin 32 is brought into contact with the vertical wall portion 14b in the release direction, the pressing portion 33 can be brought into contact with the receiving portion 62.

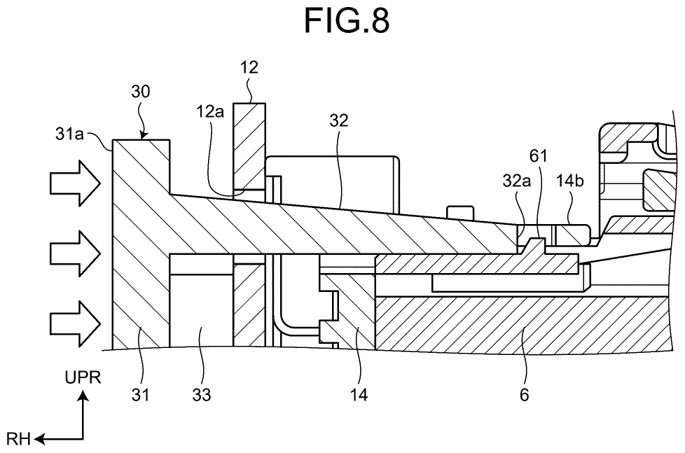

When the device box 5 is crushed, the housing 13 is crushed, as illustrated in FIG. 8, the load to be crushed is inputted to the plane 31a of the flat plate portion 31, the flat plate portion 31 is pressed in the release direction with the load of crushing. The release member 30 by the flat plate portion 31 is pushed in the release direction is moved in the release direction, the distal end portion 32a of the release pin 32 pushes down the claw 61 of the female connector 6 to remove. That is, the release member 30 is moved in the release direction, pushing the claw 61 in a direction to release the locking state between the claw 61 and the vertical wall portion 14b. The pressing portion 33 until the claw 61 is removed is set a gap so as not to contact the female connector 6. When the release member 30 in a state where the pawl 61 is disengaged is further moved in the release direction, the pressing portion 33 abuts against the receiving portion 62, the pressing portion 33 pushes the body of the female connector 6 in the release direction. As a result, the female connector 6 can be pushed out in the release direction to a position where the female connector 6 is disengaged from the pin of the male connector 14, thereby physically disconnecting the female connector 6 from the high voltage circuit 11.

When the housing 13 with the crushing of the equipment box 5 is crushed, the housing 13 abuts against the release member 30. At that time, when the release direction of the load is input from the housing 13 to the release member 30, the release member 30 is moved in a direction to release the connection of the female connector 6 to apply a load to release the connection between the male connector 14 to the female connector 6. Thus, the release member 30 is moved relative to the base 12 in a direction to release the connection of the female connector 6 to release the connection of the female connector 6.

As described above, according to the embodiment, the battery cells can be physically disconnected from the high-voltage circuitry 11 by utilizing the load when the battery ECU 3 collapses. Accordingly, even when the battery ECU 3 is crushed and the housing 13 and the base 12 are in contact with each other, or the base 12 is in contact with each other, since it does not become a short circuit between the high-voltage circuit 11 and the battery cell, it is possible to avoid heat generation of the battery cell. According to the connection structure 1, it becomes possible to prevent heat generation of the battery cell from a short circuit that cannot be protected by a fuse, a structure that can ensure safety.

Incidentally, the arrow UPR illustrated in the figures represents the upward direction of the electric vehicle. Similarly, the arrow RH represents the right-hand direction of the electric vehicle, and the arrow FR represents the forward direction of the electric vehicle. The opposite direction of the arrow UPR is the downward direction of the electric vehicle. The opposite direction of the arrow RH represents the leftward direction of the electric vehicle. The opposite direction of the arrow FR represents the rear direction of the electric vehicle. The direction in which the female connector 6 is disconnected, i.e. the release direction, is the opposite direction of the arrow RH (leftward direction of the electric vehicle). The direction for releasing the locked condition between the claw 61 and the standing wall portion 14b is the opposite direction of the arrow UPR (downward direction of the electric vehicle). The horizontal direction is the lateral direction of the electric vehicle (vehicle width direction of the electric vehicle).

Further, the member for electrically connecting between the female connector 6 and the battery module 2 is not limited to the FPC 7, a bus bar or may be a conductive member having flexibility.

The direction to release the connection of the female connector 6 is not limited to the opposite direction of the arrow RH (left direction of the electric vehicle), it may be any horizontal direction. For example, the direction to release the connection of the female connector 6 may be the arrow RH (rightward direction of the electric vehicle), the arrow FR (forward direction of the electric vehicle) may be the opposite direction of the arrow FR (rear direction of the electric vehicle).

In the present disclosure, the first connector and the second connector can be physically disconnected by the load input from the housing to the release member. Thus, it is possible to avoid heat generation of the battery cell even if a short circuit occurs in the electronic device side.

Although the disclosure has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A connection structure in which an electronic device having a high voltage circuit and a battery module having a plurality of battery cells are electrically connected via a connector, wherein
the connector includes
a first connector provided on a side of the electronic device, which is connected to the high voltage circuit, and
a second connector provided on a side of the battery module, which is connected to the first connector,
the first connector is integrated with a base on which the high voltage circuit is provided,
the electronic device includes a release member, which relatively moves towards a direction to release the connection of the second connector with respect to the base to release the connection of the second connector, the release member being provided in a housing accommodating the base, and
the release member, when a load in the direction to release the connection is input from the housing, moves in the direction for releasing the connection of the second connector and apply a load to the second connector so as to release the connection with the first connector.

2. The connection structure according to claim 1, wherein
the second connector has a claw for locking the first connector for prevention of disengagement,
the first connector has an engaged portion where the claw is locked,
the release member, when a load in a direction to release the connection of the second connector is input to the release member, moves in a direction to release the connection, and pushes the claw in a direction to release a state where the claw and the engaged portion are locked.

3. The connection structure according to claim 2, wherein
the release member includes
a flat plate portion, which faces the base in a horizontal direction and is provided on a side opposite to a side of the first connector with respect to the base, and
a release pin, which protrudes in the horizontal direction from the flat plate and towards the side of the first connector so as to release the claw from the engaged portion, and
a horizontal distance between the base and the flat plate portion is longer than a horizontal distance between the release pin and a pawl in a state where the release member is not moved in a direction to release the connection.

4. The connection structure according to claim 3, wherein
the engaged portion is located ahead of the claw in a direction to release the connection.
